(19) United States
(12) Patent Application Publication
(10) Pub. No.: US 2011/0304232 A1
(43) Pub. Date: Dec. 15, 2011

(54) ELECTROMAGNETICALLY DRIVEN MOTOR AND ELECTRIC POWER GENERATOR

(76) Inventor: Garland Rush, Sonoma, CA (US)

(21) Appl. No.: 13/217,166

(22) Filed: Aug. 24, 2011

Related U.S. Application Data
(63) Continuation-in-part of application No. 12/791,780, filed on Jun. 1, 2010, now abandoned.
(60) Provisional application No. 61/182,673, filed on May 29, 2009.

(51) Int. Cl. H02K 47/20; H02K 7/09

(52) U.S. Cl. 310/90.5; 310/113

(57) ABSTRACT

Method and apparatus for powering an electric motor by circumferentially positioning an array of drive magnets on a rotor and positioning a series of electromagnets on a platform surrounding the drive magnets. The electromagnets are energized and provided with a repulsive polarity at exact time and position necessary to repel a corresponding drive magnet on the rotor so as to drive the rotor in one direction. The rotor includes arrays of permanent magnets that induce current in wire coils circumferentially disposed in one or more stators around and in close proximity to the induction magnets.

### CROSS REFERENCES TO RELATED APPLICATIONS

The present application is a continuation-in-part of U.S. patent application Ser. No. 12/791,780, filed Jun. 1, 2010, which claims the benefit of U.S. Provisional Patent Application Ser. No. 61/182,673, filed May 29, 2009.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

1. Field of the Invention

The present invention relates generally to electric motors, and more particularly to a electromagnetically driven motor and electric power generator.

2. Discussion of Related Art including information disclosed under 37 CFR §§1.97, 1.98:

Optimal mechanical efficiency and power conservation in electric motors and electric power generators is an implicit and tacit objective, yet it is of paramount importance. Indeed, it is in the very nature of such machines to be efficient. To that end, a well known means of improving efficiency in motors has been through the reduction of friction between moving parts in contact with one another. Most often that is achieved by introducing a lubricant between the parts.

Another objective, now also of paramount importance, is that of being environmentally clean. To that end, it is increasingly desirable to employ only those engines and motors that provide motive force, and electrical power generators that provide electrical energy, without the consumption of fossil fuels.

### BRIEF SUMMARY OF THE INVENTION

The present invention harnesses the energy contained in the magnetic fields of permanent magnets to assist in driving an electric motor. More specifically, the present invention provides a way to exploit the motive force available when two magnets having identical polarity are brought into proximity. In the present invention, this is accomplished by circumferentially positioning an array of permanent magnets (“drive magnets”) on a rotor and positioning a series of electromagnets on a platform surrounding the drive magnets. The electromagnets are energized and provided with a repulsive polarity only at the exact time and position necessary to repel a corresponding drive magnet on the rotor so as to drive the rotor in one direction. The rotor includes one or more other circumferentially disposed arrays of permanent magnets (electrostatic “induction magnets”), as well, but these other sets of magnets are employed to induce current in circumferentially disposed wire coils in proximity to the induction magnets.

### BRIEF DESCRIPTION OF THE SEVERAL VIEWS OF THE DRAWINGS

FIG. 1A is a schematic upper perspective view showing a first preferred embodiment of the electromagnetically driven motor and electric power generator of the present invention;

FIG. 1B is a schematic exploded view thereof; and

FIG. 2 is a schematic upper perspective view of a second preferred embodiment of the electromagnetically driven motor and electric power generator of the present invention;

FIG. 3 is a schematic exploded upper perspective view of a third preferred embodiment of the motor and electric power generator of the present invention;

FIG. 4 is an upper perspective view thereof;

FIG. 5 is a lower exploded perspective view showing the lower portion of the apparatus without the stators shown; and

FIG. 6 is an upper perspective view showing an alternative embodiment of the apparatus of FIGS. 3-5, in which the ring of electromagnets has been replaced by a linear induction motor ring.

### DETAILED DESCRIPTION OF THE INVENTION

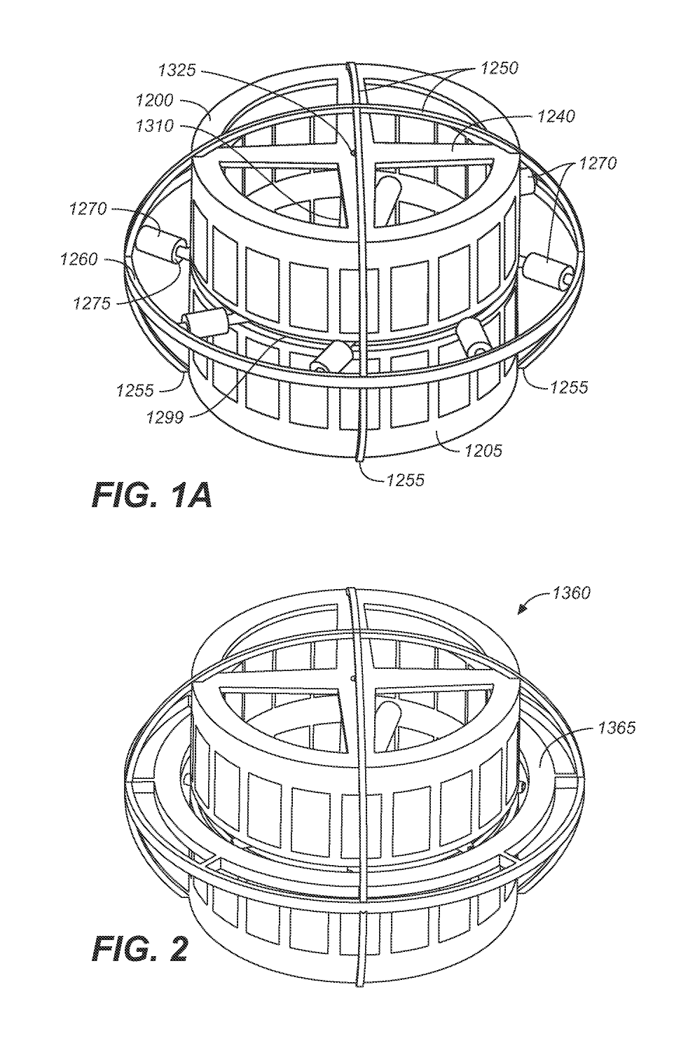

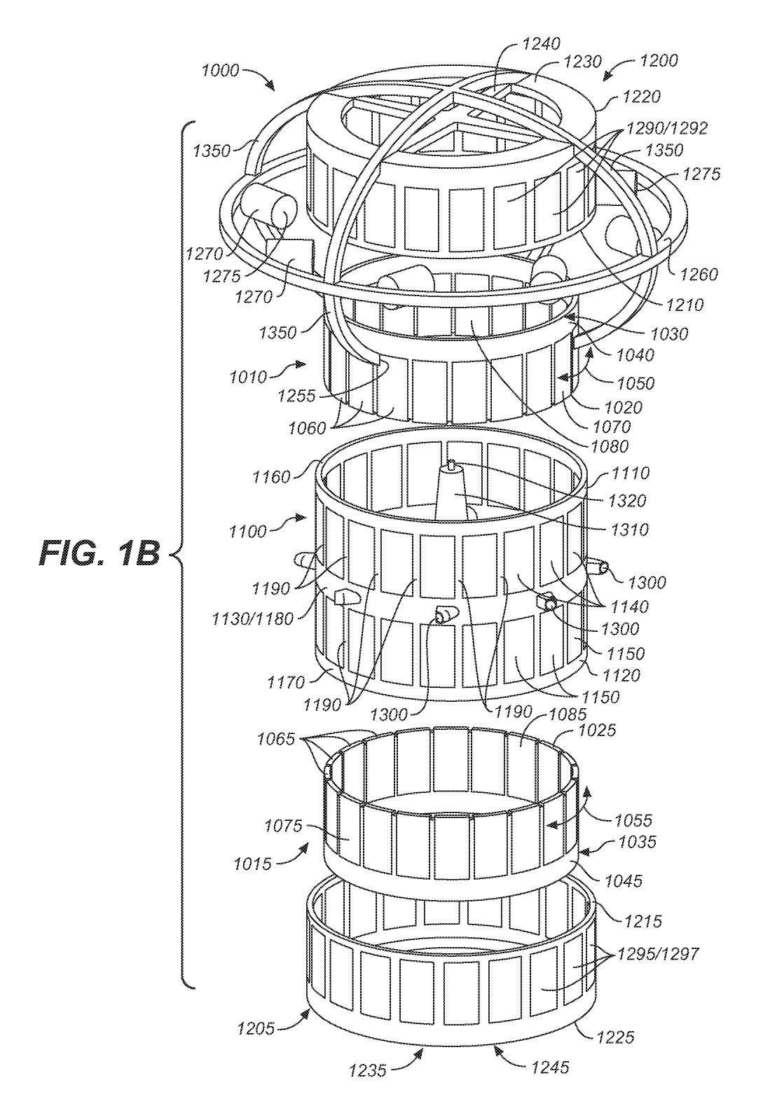

Referring next to FIGS. 1A and 1B, there is shown a first preferred embodiment of the electromagnetically driven motor and electric power generator of the present invention. This embodiment in its entirety bears reference number 1000 herein. Collectively, these figures show that the inventive apparatus comprises generally cylindrical upper and lower inner stators 1010, 1015, respectively, each having a proximal end 1020, 1025, a distal end 1030, 1035, an annular structural ring formed in the distal end 1040, 1045, an outer circumferential dimension 1050, 1055, and a plurality of coil windings 1060, 1065 embedded in the annular structural ring or otherwise affixed to the body of its respective inner stator in an array of columns or rows such that both the inner and outer surfaces 1070, 1075, and 1080, 1085, respectively, of the coil containers are exposed or only lightly protected by a thin layer of non-ferrous material.

Next, the inventive electromagnetic electric generator apparatus includes a substantially cylindrical rotor 1100 having an inside diameter and an outside diameter (not indicated by reference numbers), the inside diameter slightly larger than the outside diameter or outside circumferential dimension of the upper and lower inner stators, such that the inner stators insert into the rotor with an acceptable clearance for free rotation, and optimal magnetic levitation relative to both the upper and lower outer stators 1200, 1205 (the latter elements to be described in detail below), and optimal induction during operation (also to be described below). The rotor has an upper end 1110 and a lower end 1120, and a circumferential midline 1130. An upper and lower row of permanent magnets 1140, 1150 are each arrayed in rows on the upper and lower sides, respectively, of the circumferential midline. Upper and lower structural rings 1160, 1170 integrally connect with a medial circumferential ring 1180 with vertical slats 1190 to form the framework within which the magnets are disposed.

Next, it will be seen that a plurality of permanent magnets 1000 are circumferentially disposed around the circumferential midline 1130 and medial ring 1180 of the rotor. The magnets are oriented with exposed poles angled rearwardly relative to the direction of rotation of the rotor. An axially oriented spindle 1310 having a center axle 1320 spans the distance from the upper to lower edges of the rotor and is affixed to the medial ring with radially extending spokes or a concentrically disposed solid plate or disk (not shown) which connects to the inner wall of the rotor at the circumferential midline.

Next, the inventive electromagnetically driven electric generator includes substantially cylindrical upper and lower outer stators 1200, 1205. Each outer stator in the assembly includes an inside diameter and an outside diameter (not indicated by reference numbers), the inside diameters being slightly larger than the outside diameter of the rotor, such that the rotor inserts into the outer stators with an acceptable clearance for free rotation of the rotor within the outer stators, and for optimal magnetic levitation of the rotor relative to the outer stators, and for optimal induction during operation. The upper and lower outer stators each include a proximal end 1210, 1215 and a distal end 1220, 1225, and an inwardly projecting ring or cap 1230, 1235 disposed at the respective distal ends and to which the upper and lower inner stators are affixed in a spaced apart relationship such that the rotor is disposed between the inner stators and outer stators with a small clearance.

Each of the upper and lower outer stators also includes either cross members 1240, 1245 or end plates having, both possible structures including a center bearing or bushing 1325 in which each end of axle 1320 is journalled. A plurality of outwardly extending arches 1350 connect to the upper cap 1230 of the upper outer stator 1200 and arc downwardly to a terminus 1155 generally coplanar with the cap 1235 on lower outer stator 1205.

A support ring 1260 is attached or integrally affixed to the arches for structural support and to provide a structural element for affixing a plurality of electromagnets 1270, which angle away from the direction of rotation of the rotor so as to orient the magnetic pole 1275 (which is opposite the exposed pole of permanent magnets 1300 on rotor 1100), such that the permanent magnets 1300 on rotor 1100 are repelled and driven by the electromagnets 1270 in support ring 1260.

The upper and lower outer stators each include a row 1290, 1295, respectively, of coil windings 1292, 1297, circumferentially disposed around the stators and having exposed sides, in the same manner as those of the inner stators. Thus, when the rotor is inserted between the upper and lower inner and outer stators and the axle journalled in the upper and lower bushings, the rotor circumferential midline 1130 is concentric with the support ring 1260, thereby bringing the rotor's permanent magnets 1360, into concentric alignment with electromagnets 1270, and the upper and lower inner and outer stators are held in a spaced apart relationship, the former to accommodate and allow movement of the center plate or spokes 1390 extending from spindle 1310, and the latter to accommodate and allow free movement of the rotor. The space or gap 1299 between the upper and lower outer stators is shown in FIG. 1A.

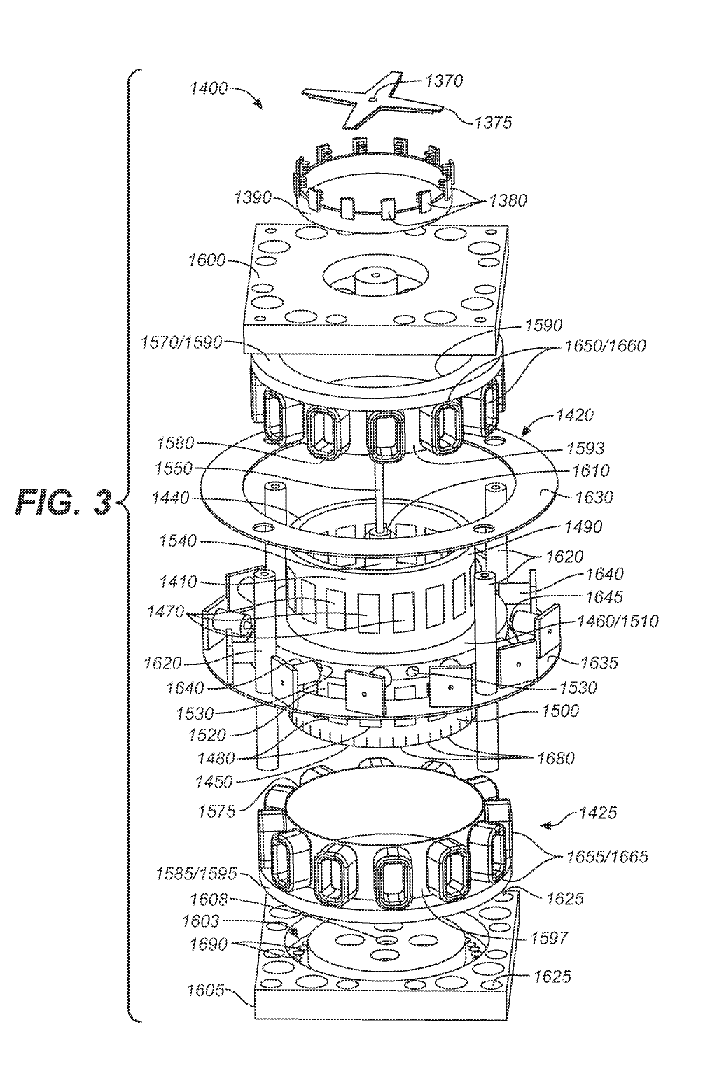

Referring now to FIG. 2, there is shown a second preferred embodiment 1360 of the inventive electromagnetically driven motor and electric power generator of the present invention. In this embodiment all of the structural and operative elements are identical to those of the second preferred embodiment, except that electromagnets 1270 are replaced by a high speed linear synchronous motor or linear induction motor ring (LSM ring) 1365 comprising a plurality of electromagnets configured in an annular array. In effect, this is the same device as that shown in FIGS. 1A-1B, but includes a substantially continuous ring of electromagnets rather than an array of a relatively small or limited number of spaced apart magnets.

In either of the second and third embodiments shown in FIGS. 1 through 2, respectively, the electromagnets may be pulsed (that is, turned on and off) in a sequence. Additionally, they can be provided with power in a precise manner so as to control the rotation speed of the rotor. The electric pulses can be timed by a circuit that includes optical infrared sensors disposed around the circumferential LSM ring 1365 or support ring 1260, and which sense the proximity of a surface of magnets 1300, adjusting the pulse timing according to the then current speed of the rotor.

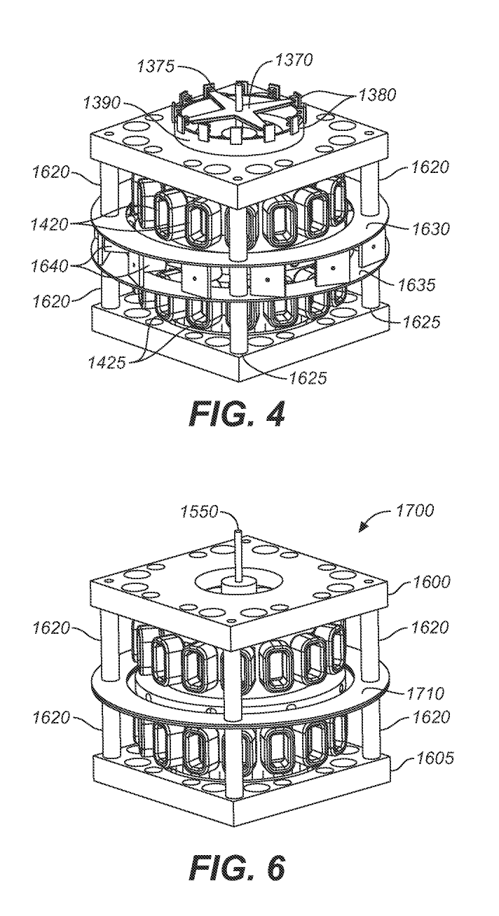

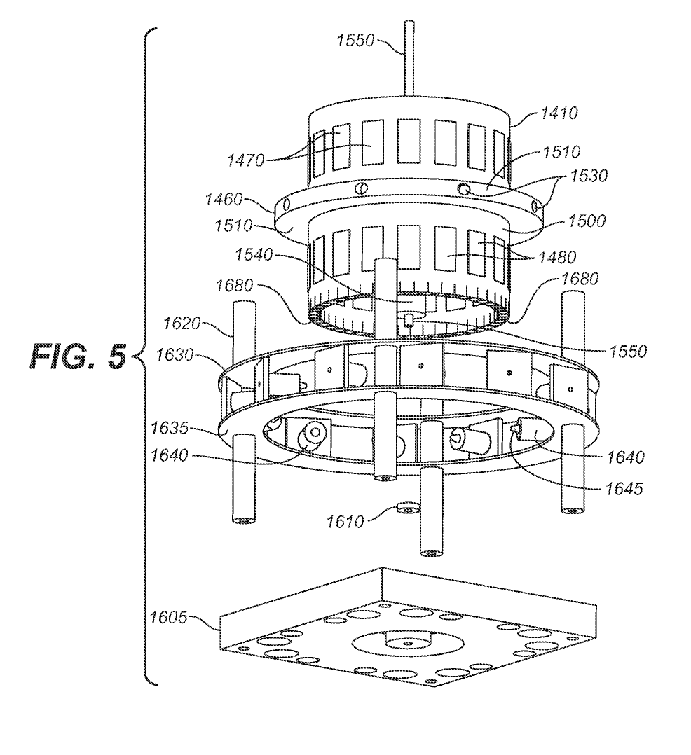

Referring next to FIGS. 3-5, there is shown a fourth preferred embodiment of the electromagnetically driven motor and electric power generator of the present invention, generally denominated 1400 herein. In this embodiment, the inventive apparatus includes generally cylindrical upper and lower stators 1420, 1425, respectively, each having a proximal (upper) edge or end 1570, 1575 (as viewed from the top down), a distal (lower) edge or end, 1580, 1585 an annular structural mounting ring, 1590, 1595, first and second sets 1650, 1655, respectively, of coil windings, 1660, 1665, circumferentially disposed around the upper and lower stator drums, 1593, 1597, respectively, and having exposed sides, or sides lightly covered with a thin layer of non-ferrous material. Each stator in the assembly includes an inside diameter and outside diameter (not indicated by reference numbers), the stator inside diameters being slightly larger than the outside diameter of the rotor 1410, such that the rotor inserts into the stators with an acceptable clearance for free rotation of the rotor within the stators, and for optimal induction during operation. As is shown, each of the upper and lower stator coil rings, 1660, 1665 are affixed to their respective stator drum, which is, in turn, attached to a structural mounting ring, 1590, 1595, the upper of which attaches to top plate, 1600, and the bottom of which attaches to base plate, 1605.

The supportive frame for this embodiment includes an upper (top) plate 1605 and lower (base) plate 1605, each including a center bearing or bushing 1608, in which a bearing 1610 on center axle 1550 is seated. A plurality of outer columnar supports 1620 connect at connection points 1625 upper and lower plates, 1600, 1605. A plurality of levitation magnets 1680 are disposed in the distal (lower) end 1450 of the rotor 1410 and in an annular channel 1603 in the base plate 1605, and the absence of bearings or other surface contacts allows the rotor to spin on center axle with greatly reduced friction.

The substantially cylindrical rotor, 1410, has an inside diameter and an outside diameter (not indicated by reference numbers), the outside diameter being slightly smaller that the inside diameter of the upper and lower stator mounting rings, 1590, 1595. The rotor 1410 has an upper end, 1440 and a lower end, 1450, and a circumferential midline, 1460. An upper and lower set of permanent magnets, 1470, 1480 are each circumferentially arrayed in rows on the upper and lower sides, respectively, of the circumferential midline, 1460. Upper and lower structural rings, 1490, 1500 integrally connect with a medial circumferential ring 1510 with vertical slats 1520 to form framework within which the rows of magnets 1470, 1480 are disposed.

As in the earlier embodiments, this embodiment includes an electromagnetic drive assembly that includes a plurality of drive magnets 1530, which are also permanent magnets, and which are circumferentially disposed around the circumferential midline, 1460 and medial ring, 1510 of the rotor. The magnets are oriented with exposed poles angled rearwardly relative to the direction of rotation of the rotor. An axially oriented spindle 1540 having a center axle, 1550 spans the distance from the upper to lower edges of the rotor and is affixed to the medial ring with radially extending spokes (not shown) or a concentrically disposed solid plate or disc (not shown) which connects to the inner wall of the rotor at the circumferential midline.

Upper and lower support rings, 1630, 1635 are attached or integrally affixed to the supports 1620 to provide a structural base and ceiling for securing and sandwiching a plurality of electromagnets 1640, which angle away from the direction of rotation of the rotor so as to orient the magnetic pole 1645 (which is identical in polarity from the exposed pole of permanent magnets 1530 on rotor 1410), such that the permanent magnets 1530 are repelled and driven by the electromagnets 1640 in support rings 1630, 1635 when energized.

A sensor mounting ring 1390 has a plurality of electromagnet tripping sensors 1380 (photo coupled interrupter modules) mounted thereon. The tripping sensors are connected to a power supply circuit. The sensor mounting ring is affixed to the upper plate 1600, such that each tripping sensor corresponds to a single electromagnet, 1640. Next, a propeller vane, 1370 having photo interrupter blades 1375 corresponding in number to the number of permanent magnets 1530 in medial ring 1510, is positioned on center axle 1550, such that when blades 1375 interrupt the beams from sensors 1380, the power supply circuit causes a corresponding electromagnet 1640 to be energized, thereby creating an identical polarity to the outward facing pole of the most proximate permanent magnet 1530, and thus creating magnetic repulsion which causes rotor 1410 to spin.

As will be readily appreciated by those with skill, the principle of operation of the above-described third preferred embodiment is in all material respects identical to that of the first through third embodiments.

In each embodiment, the structural and operative elements are configured to enable the motor and generator to run independently of the power supply when the rotor has achieved sufficient angular momentum. In this respect, the power supply may be conceived of as a motor starting circuit which selectively and periodically energizes the electromagnet as long as necessary for the system to become self-powering and at which point the permanent magnets are the sole motive force operating on the rotor to sustain rotation. In certain systems, a shunt circuit can be connected to the output of the wire coils to function as a charging circuit. Such a circuit includes a plurality or a bank of capacitors that taps into the output circuit when the rotor is at optimal operating speed, and delivers current in pulses to the capacitors, but with a frequency that does not impose too significant a load on the rotor so as to drag it to a stop. Rather, the charging circuit is controlled so as to permit the rotor to rebuild to optimal speed after current is siphoned off. The capacitors periodically discharge into batteries.

In FIG. 6 there is shown a fourth preferred embodiment of the inventive electromagnetically driven electric power generator. In this instance, the medial assembly of electromagnets shown in FIGS. 3-5 is replaced by a linear synchronous motor or linear induction motor ring (LSM ring) 1710 comprising a plurality of electromagnets configured in an annular array. Again, this is essentially the same device as that shown in FIGS. 3-5, but includes a substantially continuous ring of electromagnets rather than an array of a relatively small or a limited number of spaced apart electromagnets.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which shall be defined by the claims filed concurrently with a successor non-provisional, regular national utility patent application.

What is claimed as invention is:

1. An electromagnetically driven motor and electric power generator, comprising:
a mounting frame including a base plate, a top plate, a support platform between said base plate and said top plate, and a plurality of vertical support elements joining said top plate, said base plate, and said support platform;
at least one generally cylindrical stator including a drum having an interior diameter;
a plurality of wire coils circumferentially disposed around the exterior side of said drum;
a generally cylindrical rotor axially disposed inside said at least one stator on a center axle and having an upper end, a lower end, and an outer diameter slightly smaller than the diameter of said drum such that the gap between said drum and said rotor allow for free rotation of said rotor within said stator, said axle being connected at its ends in said top and said bottom.
an annular array of drive magnets disposed around said rotor and having exposed and outwardly facing poles angled rearwardly relative to the direction of rotation of the rotor when in operation;
at least one row of permanent magnets circumferentially disposed on and around said rotor in a generally annular array and aligned with said wire coils such that said permanent magnets induce electric current in said wire coils as said rotor turns;
an array of electromagnets disposed on said support platform, said electromagnets oriented with a magnetic pole having a polarity when energized that is identical to that of the exposed pole of said drive magnets on said rotor, such that the drive magnets are repelled by said electromagnets when energized and said rotor is driven in a predetermined direction of rotation; and
a power supply circuit that energizes each of said electromagnets to provide them with a repulsive polarity at the time and position necessary to repel a most proximate drive magnet on said rotor so as to drive the rotor in one direction.

2. The electromagnetically driven motor and electric power generator of claim 1, wherein said at least one stator includes a cylindrical upper stator and a cylindrical lower stator, each of which includes a substantially cylindrical body having an upper end, a lower end, an inside diameter, and outside diameter, and annular structural mounting ring, and wherein said rotor has an outer diameter slightly smaller than the interior diameter of said stators and inserts into and between said lower end of said upper stator and said upper end of said lower stator with an acceptable clearance for free rotation of the rotor within the stators.

3. The electromagnetically driven motor and electric power generator of claim 2, wherein said rotor further includes a circumferential midline exposed between said lower end of said upper stator and said upper end of said lower stator, and wherein said drive magnets are disposed around said circumferential midline.

4. The electromagnetically driven motor and electric power generator of claim 3, wherein said rotor has an upper set of permanent magnets positioned above said circumferential midline and a lower set of permanent magnets disposed below said circumferential midline.

5. The electromagnetically driven motor and electric power generator of claim 4, wherein said rotor includes a medial ring extending outwardly from said circumferential midline, and said drive magnets are disposed in said medial ring

6. The electromagnetically driven motor and electric power generator of claim 1, wherein said center axle includes a bearing at each of its upper and lower ends, each journalled in a bushing disposed in each of said base plate and said top plate.

7. The electromagnetically driven motor and electric power generator of claim 6, wherein said rotor is connected to said center axle at the circumferential midline with either a concentrically disposed disk or a plurality of radially extending spokes

8. The electromagnetically driven motor and electric power generator of claim 1, wherein said upper end of said upper stator includes a mounting ring connected to said top plate, and said lower end of said lower stator includes a mounting ring connected to said base plate.

9. The electromagnetically driven motor and electric power generator of claim 1, wherein said support platform includes spaced apart upper and lower support rings attached to said vertical support elements, and wherein said electromagnets are disposed between said support rings.

10. The electromagnetically driven motor and electric power generator of claim 1, wherein said vertical support elements include columnar supports connected at connection points in each of said top and base plates.

11. The electromagnetically driven motor and electric power generator of claim 1, further including a plurality of levitation magnets disposed in said lower end of said rotor and in an annular array on said base plate immediately under said levitation magnets in said rotor.

12. The electromagnetically driven motor and electric power generator of claim 11, wherein said levitation magnets in said base plate are set in an annular channel formed in said base plate.

13. The electromagnetically driven motor and electric power generator of claim 1, further including a sensor mounting ring having a plurality of electromagnet tripping sensors mounted on said top plate and electrically coupled to said power supply circuit, each of said tripping sensors corresponding to a single electromagnet, and a propeller vane having photo interrupter blades corresponding in number to the number of drive magnets in said medial ring and connected to said center axle, such that when said photo interrupter blades interrupt beams from said tripping sensors, said power supply circuit causes a corresponding electromagnet to be energized.

14. The electromagnetically driven motor and electric power generator of claim 1, wherein said power supply circuit includes a plurality of tripping sensors corresponding in number to the number of drive magnets and controlled by the spatial relationship of the drive magnets to the electromagnets during rotor rotation, such that said tripping sensors allow current to be provided to each of said electromagnets and thereby create an identical polarity between the energized electromagnet and the most proximate drive magnet only at the time and position necessary to repel a corresponding drive magnet on the rotor so as to drive the rotor in one direction.

15. An electromagnetically driven motor and electric power generator, comprising:
a mount including a top side and a base side;
at least one generally cylindrical stator including a drum having an interior diameter;
a plurality of wire coils circumferentially disposed around the exterior side of said drum;
a generally cylindrical rotor axially disposed and centered inside said at least one stator so as to form a small gap between said stator and said rotor;
an array of drive magnets disposed on said rotor;
a plurality of permanent magnets disposed on said rotor in alignment with said wire coils such that said permanent magnets induce electric current in said wire coils as said rotor turns; and
a plurality of electromagnets spaced apart from said drive magnets positioned and oriented such that the poles of said electromagnets when energized have a polarity identical to that of the exposed poles of said drive magnets, thereby creating a repelling force between said
electromagnets when energized and said drive magnets.

16. The electromagnetically driven motor and electric power generator of claim 13, further including a center axle to which said rotor is connected, wherein said center axle is connected at its ends to said top side and said base side of said mount.

17. The electromagnetically driven motor and electric power generator of claim 13, further including a plurality of levitation magnets disposed in said rotor and a plurality of levitation magnets disposed in said stator and said top and bottom sides of said mount such that said rotor is substantially centered and spaced apart from said stator and said mount.

18. The electromagnetically driven motor and electric power generator of claim 13, further including an electromagnet energizing circuit that energizes said electromagnets to provide them with a repulsive polarity at the time and position necessary to repel said drive magnets so as to urge said rotor in one direction.

19. An electromagnetically driven motor and electric power generator, comprising:
a generally cylindrical stator having an upper portion and a lower portion, and inner side and an outer side;
a plurality of wire coils disposed on said outer side of said stator;
an electric output circuit electrically coupled to said plurality of wire coils;
a generally cylindrical rotor rotatably disposed inside said stator ;
a plurality of drive magnets disposed on said rotor with outwardly facing poles angled away from the direction of rotation of the rotor when in operation;
a plurality of permanent magnets disposed on said rotor and aligned with said wire coils such that said permanent magnets induce electric current in said wire coils as said rotor turns;
a plurality of electromagnets positioned around said rotor in alignment with said drive magnets and having a polarity at their respective magnetic poles when energized that matches the polarity of the magnetic poles of the exposed ends of said drive magnets on said rotor;
an electric starter circuit for selectively and periodically energizing each of said electromagnets to provide them with a repulsive polarity at the time and position necessary to repel said drive magnets; and
a shunt circuit including a plurality of capacitors for directing current from said output circuit to said capacitors and periodically discharging stored charge into storage devices.

20. The electromagnetically driven motor and electric power generator of claim 17, wherein said storage devices are batteries.
